(19) United States
(12) Patent Application Publication
(10) Pub. No.: US 2016/0375561 A1
(43) Pub. Date: Dec. 29, 2016

(54) RATCHET WRENCH ABLE TO AUTOMATICALLY ADJUST ENGAGING TOOTH NUMBER ACCORDING TO EXTENT OF TORSION

(71) Applicant: Chia-Yu CHEN, Taichung City (TW)

(72) Inventor: Chia-Yu CHEN, Taichung City (TW)

(21) Appl. No.: 14/750,025

(22) Filed: Jun. 25, 2015

(51) Int. Cl. B25B 13/46

(52) U.S. Cl. CPC B25B 13/463

(57) ABSTRACT

A ratchet wrench able to automatically adjust engaging tooth number according to extent of torsion includes a ratchet block having two ends respectively extending to form an extension portion able to be optionally pushed and stuck between a ratchet ring and the resisting surface of a ratchet moving groove. The engaging surface of the ratchet block is a concave arcuate surface, and the ratio of the radius of the concave arcuate surface and the radius of the ratchet ring is between 1.017 and 1.033. Thus, when the ratchet block bears high torsion, the extension portion will be pushed toward the ratchet ring and the resisting surface of the ratchet moving groove to be pushed by the resisting surface to increase mutually engaging tooth number of the ratchet block and the ratchet ring, thus enabling the ratchet block to automatically adjust engaging tooth number according to extent of torsion.

### BACKGROUND OF THE INVENTION

1. Field of the Invention

This invention relates to a ratchet wrench, particularly to one able to automatically adjust engaging tooth number according to extent of torsion.

2. Description of the Prior Art

A conventional ratchet wrench, as shown in FIG. 1, is pivotally formed with a ratchet ring 3, and a ratchet block 1 is provided at the circumferential side of the ratchet ring 3 and has one side engaged with the ratchet ring 3 and another side pushed by a push number 2 so that the push number 2 can optionally control the engagement relation between the ratchet block 1 and the ratchet ring 3. One side of the ratchet block 1, which is engaged with the ratchet ring 3, is a cambered surface whose curvature radius is the same as that of the ratchet ring 3 so that when the ratchet wrench is turned for use, the ratchet block 1 can be pushed by the push member 2 to be closely fitted with the ratchets of the ratchet ring 3 to enable all the ratchets of the ratchet block 1 to bear force and form an engaged state, letting the force to evenly fall on each ratchet of the force bearing tooth surface. Thus force can be distributed and the engaging force of each ratchet becomes comparatively stable and certain and hence, thus enabling the ratchet wrench to bear higher torsion value.

However, when the conventional ratchet wrench is turned for use, although each ratchet of the ratchet block 1 bears force to be engaged with the ratchet of the ratchet ring 3 to enable each ratchet of the ratchet block 1 to be engaged with the ratchet ring 3 with great stability and certainty, yet when combined with a ratchet ring of a ratchet wrench, which is formed with more than 108 teeth, the ratchets of the ratchet block 1 are likely to be worn away and difficult to be disengaged from the ratchet ring 3. Therefore, when a user wants to carry out quick and simple operation and use of the ratchet wrench only with low torsion, the ratchet wrench having difficulty in disengaging the ratchet block 1 form the ratchet ring 3 may cause much inconvenience to the user. In view of above-mentioned drawback, the inventor of this invention thinks that the conventional ratchet wrench has to be ameliorated.

### SUMMARY OF THE INVENTION

The objective of this invention is to offer a ratchet wrench able to automatically adjust engaging tooth number according to extent of torsion. In this invention, the engaging tooth number of a ratchet block and a ratchet ring can be adjusted when high torsion or low torsion is applied. When high torsion is used, each ratchet of the ratchet block of the ratchet wrench can be certainly engaged and bear force for stably bearing high torsion. When low torsion is used, the engaging tooth number of the ratchet block and the ratchet ring is reduced for overcoming the problems that the ratchet block of a conventional ratchet wrench is apt to be worn away and that the ratchet block is difficult to be disengaged from the ratchet ring, thus enhancing convenience in using and operating the ratchet wrench.

The ratchet wrench able to automatically adjust engaging tooth number according to extent of torsion in the present invention includes a wrench body formed with a shank, which is formed with a head at one side. The head is longitudinally provided with an accommodating hole, and a control groove at a location adjacent to the shank, and the accommodating hole of the head is transversely bored with a ratchet moving groove, with the accommodating hole communicating with the control groove, and the ratchet groove expanded gradually from the control groove toward the accommodating hole. A ratchet ring is pivotally received in the accommodating hole, having its outer circumference annularly provided with a plurality of driving teeth and its center disposed with a braking member for correspondingly turning around a work piece. A ratchet block is installed in the ratchet moving groove and formed with an engaging surface at one side facing the accommodating hole. The engaging surface is a concave arcuate surface and the ratio of the radius of the concave arcuate surface and the ratchet ring is between 1.017 and 1.033, and the engaging surface is provided with a plurality of ratchets that can be optionally engaged with the driving teeth of the ratchet ring. The ratchet block is further provided with a resisted surface at one side facing the control groove, and has two transverse ends respectively extending outward to form an extension portion, which is contracted gradually from the resisted surface toward the engaging surface of the ratchet block, and the extension portion can be optionally pushed to be stuck between the circumferential walls of the ratchet ring and the ratchet moving groove. A control device is received in the control groove to elastically push against the resisted surface of the ratchet block, able to optionally control the engaging relation between the ratchet block and the ratchet ring.

The ratchet wrench able to automatically adjust engaging tooth number according to extent of torsion in the present invention has the ratchet block provided with the engaging surface whose radius is a little larger than the radius of the ratchet ring so that when the ratchet block bears high torsion, the extension portion of the ratchet block can be actuated to push against the circumferential wall of the ratchet moving groove to increase engaging tooth number of the ratchet block and the ratchet ring and make each ratchet of the ratchet block engaged and bear force certainly for stably bearing high torsion. When the ratchet block bears low torsion, the force that the extension portion of the ratchet block pushes against the circumferential wall of the ratchet moving groove is reduced for lessening the engaging tooth number of the ratchet block and the ratchet ring, thus avoiding the ratchet block being worn away, enabling the ratchet block to carry out ratchet disengagement quickly and easily and hence elevating convenience in using and operating the ratchet wrench.

### BRIEF DESCRIPTION OF DRAWINGS

This invention will be better understood by referring to the accompanying drawings, wherein:

FIG. 1 is a cross-sectional view of a conventional ratchet wrench;

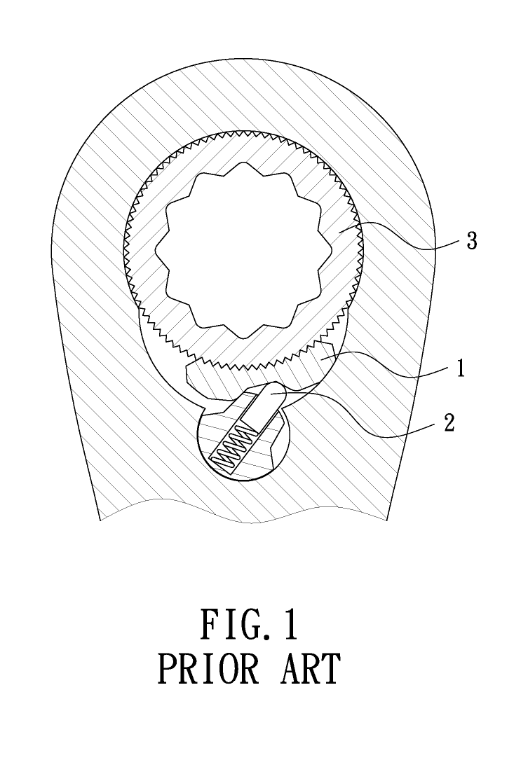

FIG. 2 is a perspective view of a ratchet wrench able to automatically adjust engaging tooth number according to extent of torsion in the present invention;

FIG. 3 is an exploded perspective view of the ratchet wrench able to automatically adjust engaging tooth number according to extent of torsion is the present invention;

FIG. 4 is a cross-sectional view of the ratchet wrench able to automatically adjust engaging tooth number according to degree of torsion in the present invention;

FIG. 5 is a schematic view of the ratchet wrench in a using condition in the present invention, showing a state of using low torsion; and

FIG. 6 is a schematic view of the ratchet wrench in a using condition in the present invention, showing a state of using high torsion.

### DETAILED DESCRIPTION OF THE PREFERRED EMBODIMENT

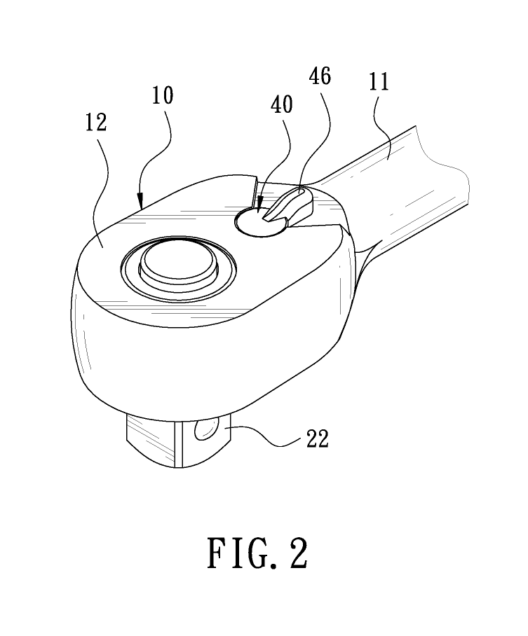

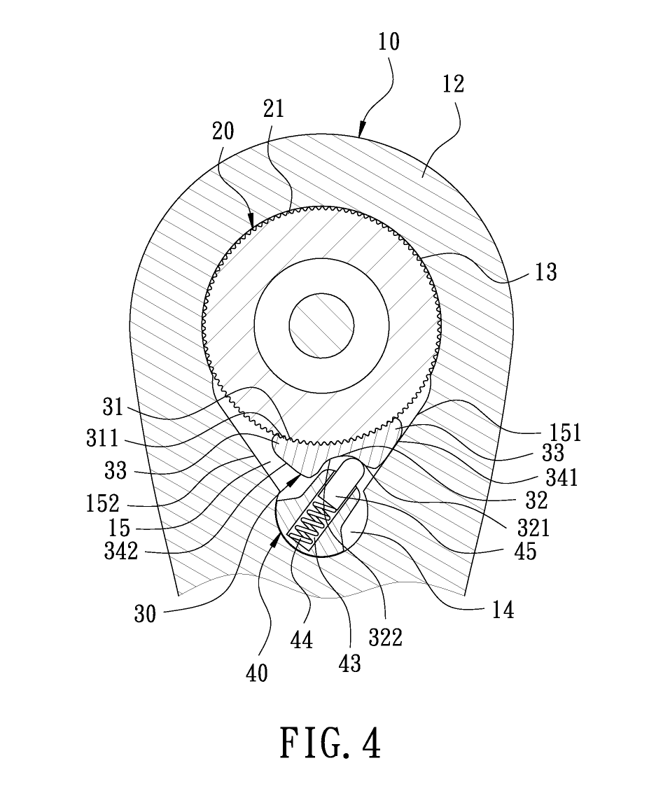

A preferred embodiment of a ratchet wrench able to automatically adjust engaging tooth number according to extent of torsion, as shown in FIGS. 2-4, includes a wrench body 10, a ratchet ring 20, a ratchet block 30, a control device 40 and a bottom plate 50 as main components combined together.

The wrench body 10 is formed with a shank 11 having one end formed with a head 12, which is formed with a topside 121 and an underside 122. The head 12 is provided with an accommodating hole 13 passing through both the topside 121 and the underside 122. The accommodating hole 13 is approximately a round shape and its central axis is perpendicular to both the topside 121 and the underside 122, and the topside 121 of the head 12 is bored with a control groove 14 at a location adjacent to the shank 11. The control groove 14 is approximately a round shape and its central axis is parallel to the center axis of the accommodating hole 13, and the head 12 is bored with a ratchet moving groove 15 communicating with the control groove 14 at a location where the accommodating hole 13 is near the shank 11. The ratchet moving groove 15 is provided with a first resisting surface 151 and a second resisting surface 152 opposite to each other, and the first and the second resisting surfaces 151 and 152 respectively extend from the topside 121 to the underside 122 of the head 12 and make the ratchet moving groove 15 contracted gradually from the accommodating hole 13 toward the control groove 14.

The ratchet ring 20 is to be pivotally received in the accommodating hole 13 of the head 12 and has its outer circumference annularly provided with a plurality of driving teeth 21. In this invention, the radius of the ratchet ring 20 is 30 mm, and the ratchet ring 20 is formed with at least 108 driving teeth 21 that are all acute angles. Further, the ratchet ring 20 is provided with a braking member 22 in the center for correspondingly turning around a work piece and, in this invention, the braking member 22 is a square-headed projection selected for corresponding with sleeves.

The ratchet block 30 is received in the ratchet moving groove 15 and can be optionally engaged with the ratchet ring 20. The ratchet block 30 is disposed with an engaging surface 31 at one side facing the accommodating hole 13. The engaging surface 31 is a concave cambered surface, and the ratio of the radius of the concave cambered surface and the radius of the ratchet ring 20 is between 1.017 and 1.033. In this invention, the radius if the concave cambered surface is between 30.5 mm and 31 mm. The engaging surface 31 of the ratchet block 30 is provided with a plurality of ratchets 311, which can be optionally engaged with the driving teeth 21 of the ratchet ring 20. Further the ratchet block 30 is formed with a resisted surface 32 at one side facing the control groove 14, and resisted surface 32 is formed into a concave arcuate shape and has two sides respectively formed with a first resisted surface 321 and a second resisted surface 322. Furthermore, the ratchet block 30 has two transverse sides respectively extending outward to form an extension portion 33, which is gradually contracted from the resisted surface 32 toward the engaging surface 31 of the ratchet block 30 to have one side of the ratchet block 30, which faces the first resisting surface 151 of the ratchet moving groove 15, correspondingly formed with a first pushing surface 341, which is optional to be closely fitted with the first resisting surface 151, while the ratchet block 30 is correspondingly formed with a second pushing surface 342 at one side facing the second resisting surface 152 of the ratchet moving groove 15 so that the second pushing surface 342 is optional to be closely fitted with the second resisting surface 152.

The control device 40 is received in the control groove 14, able to optionally control the engagement relation of the ratchet block 30 and ratchet ring 20. The control device 40 contains a control member 41, which is positioned in the control groove 14 and formed with a connecting portion 42 that protrudes out of the control groove 14 and is exposed to the interior of the ratchet moving groove 15 so that the control member 41 and the wrench body 10 can produce relative pivotal swing relation. The connecting portion 42 has one side, which faces the ratchet block 30, is longitudinally bored with a rectangular position-limiting groove 43, which, corresponding with the ratchet block 30, is longitudinally formed at the connecting portion 42 along the central axis of the control groove 14. A rectangular spring 44 is received in the rectangular position-limiting groove 43 and, corresponding to the rectangular position-limiting groove 43, the cross-section of the rectangular spring 44 is approximately a rectangular shape, and the rectangular spring 44 further elastically pushes against a push pin 45 whose longitudinal length is roughly corresponding with the longitudinal height of the ratchet block 30. The push pin 45 corresponding to the rectangular position-limiting groove 43 is approximately rectangular board-shaped, having one end received in the rectangular position-limiting groove 43 and contacting with the rectangular spring 44 and another end protruding out of the rectangular position-limiting groove 43 and longitudinally pushing against the resisted surface 32 of the ratchet block 30 along the central axis of the control groove 14, and one side of the push pin 45 is formed into a convex arcuate shape for corresponding with the resisted surface 32. In addition, the control member 41 is provided with a switch-over member 46 opposite to the connecting portion 42, with the switch-over member 46 protruding out of the topside 121 of the head 12.

The bottom plate 50 is secured at the underside 122 of the head 12 and correspondingly and annularly positioned at the outer circumference of the ratchet ring 20, able to restrictedly position the ratchet ring 20 in the accommodating hole 13 and have the ratchet block 30 restrictedly positioned in the ratchet moving groove 15.

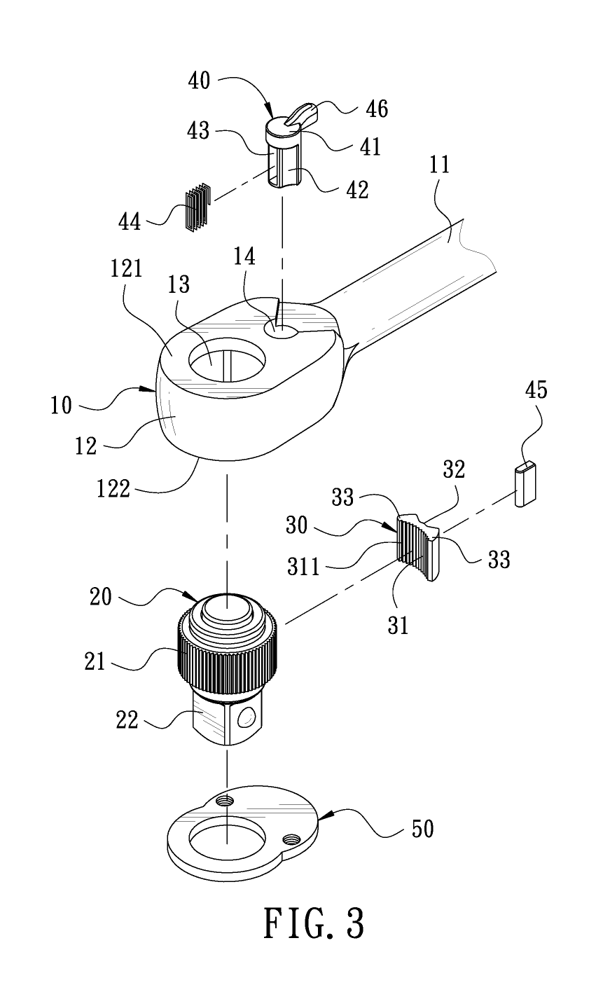

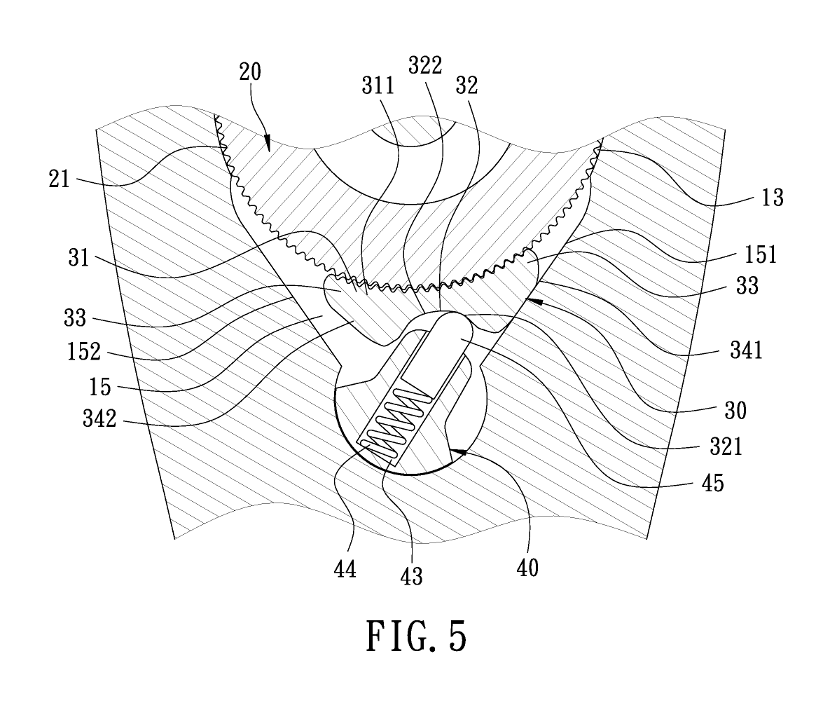

In using, referring to FIG. 5 and FIG. 3, when a user is to carry out quick and simple operation of screwing tight a work piece with low torsion, the ratchet wrench has the push pin 45 longitudinally pushing against the resisted surface 32 of the ratchet block 30 to have the pushed portion of the ratchet block 30 meshed with the ratchet ring 20 and rotated relative to the wrench body 10, letting the first pushing surface 341 of the ratchet block 30 slightly push against the first resisting surface 151 of the ratchet moving groove 15 to form a bracing surface. At this time, since the radius of the engaging surface 31 of the ratchet block 30 is somewhat larger than the radius of the ratchet ring 20; therefore, merely the pushed portion of the ratchet block 30 is meshed with the ratchet ring 20 and hence, the ratchets 311 on the ratchet block 30 can be avoided being worn away and the ratchet block 30 can quickly and easily be disengaged from the ratchet ring 20 when the wrench body 10 is rotated reversely, thus enhancing convenience in using and operating the ratchet wrench.

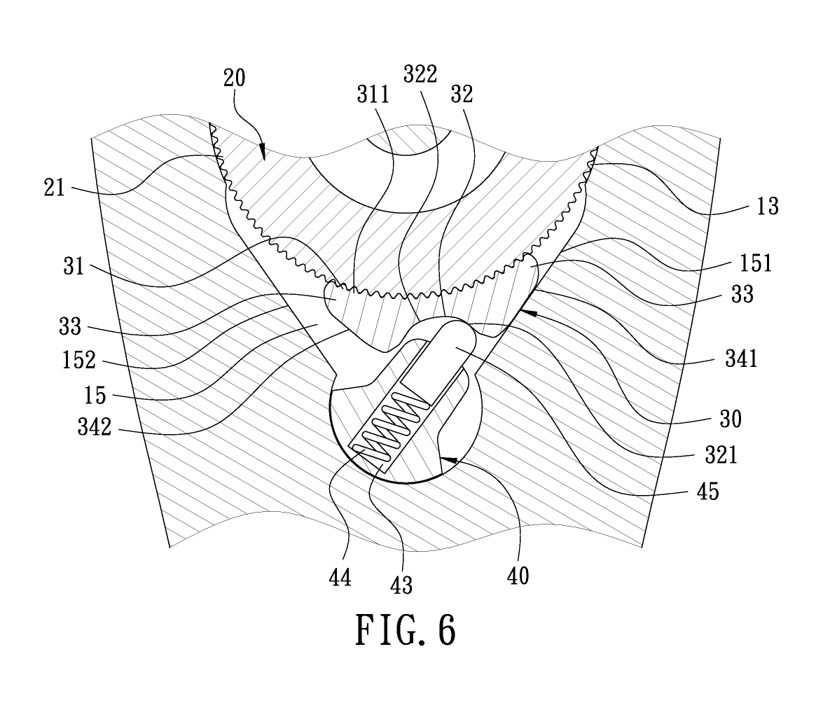

Referring to FIG. 6 together with FIG. 3, when a user is to carry out operation of screwing tight a work piece with high torsion, the ratchet block 30 will be rotated relative to wrench body 10 along with the tightening operation. At this time, since the extension portion 33 of the ratchet block 30 is gradually contracted from the resisted surface 32 toward the engaging surface 31 of the ratchet block 30; therefore, the extension portion 33 of the ratchet block 30 can be forced to get in a location between the circumferential walls of the ratchet ring 20 and the ratchet moving groove 15 to press against the circumferential wall of the ratchet moving groove 15, letting the first pushing surface 341 of the ratchet block 30 push against the first resisting surface 151 of the ratchet moving groove 15. At this time, the first pushing surface 341 and the first resisting surface 151 are closely fitted together; therefore, a rigid bracing surface can be formed, and the engaging tooth number of the ratchet block 30 and the ratchet ring 20 can be increased via the rigid bracing surface, and when turned around, the ratchet block 30 still can be completely and closely engaged with ratchet ring 20, letting bearing force evenly fall on each tooth on the force bearing tooth surface and making the engaging force of each tooth comparatively stable and certain. By so designing, the ratchet wrench of this invention can avoid causing unevenness of bearing force of the ratchet to enable the ratchet wrench to elevate effects of ratchet positioning end engaging stability and also bear higher torsion value.

To operate the wrench body 10 reversely, only turn the switch-over member 46 to have the push pin 45, which originally pushes against the first resisted surface 321, turned to push against the second resisted surface 322 of the ratchet block 30. Thus, the ratchet block 30 can be pushed to form a rigid bracing surface at the second resisting surface 152 of the ratchet moving groove 15, thus enabling a user to operate the ratchet wrench 10 reversely.

The characteristics and the anticipated efficacy attainable of this invention are stated as follows:

The ratchet wrench able to automatically adjust engaging tooth number according to extent of torsion is provided with the ratchet block with the engaging surface whose radius is a little larger than the radius of the ratchet ring so that, when the ratchet block bears high torsion, the extension portion of the ratchet block can be actuated to push against the circumferential wall of the ratchet moving groove to increase the mutually engaging tooth number of the ratchet block and the ratchet ring and have each ratchet of the ratchet block engaged and bearing force certainly for bearing high torsion more stably. When the ratchet block bears low torsion, the force that the extension portion of the ratchet block pushes against the circumferential wall of the ratchet moving groove can be lessened for decreasing the mutually engaging tooth number of the ratchet block and the ratchet ring, thus able to avoid the ratchet block being worn away and carry out ratchet disengagement quickly and easily and hence elevate convenience in using and operating the ratchet wrench.

While the preferred embodiment of the invention has been described above, it will be recognized and understood that various modifications may be made therein and the appended claims are intended to cover all such modifications that may fall within the spirit and scope of the invention.

What is claimed is:

1. A ratchet wrench able to automatically adjust engaging tooth number according to extent of torsion comprising a wrench body, said wrench body formed with a head, said head longitudinally provided with an accommodating hole and a control groove, said accommodating hole of said head transversely bored with a ratchet moving groove, said accommodating hole communicating with said control groove, a ratchet ring pivotally received in said accommodating hole, a ratchet block received in said ratchet moving groove, said ratchet block formed with an engaging surface at one side facing said accommodating hole, said engaging surface of said ratchet block able to be engaged with said ratchet ring, a control device installed in said control groove, said control device able to optionally control the engaging relation between said ratchet block and said ratchet ring, and characterized by,
said ratchet block having two transverse ends respectively extending outward to form an extension portion, said extension portion contracted gradually from a resisted surface of said ratchet block to said engaging surface of said ratchet block, said extension portions able to be optionally stuck between circumferential walls of said ratchet ring and said ratchet moving groove, said engaging surface of said ratchet block being a concave arcuate surface, a ratio of radius of said concave arcuate surface and radius of said ratchet ring being between 1.017 and 1.033;
Thus, said extension portion of said ratchet block pushed to move toward a location between circumferential walls of said ratchet ring and said ratchet moving groove when said ratchet block bears high torsion, said extension portion of said ratchet block resisted by a circumferential wall of said ratchet moving groove for increasing engaging tooth number of said ratchet block and said ratchet ring, thus enabling said ratchet block to automatically adjust engaging tooth number according to extent of torsion.

2. The ratchet wrench able to automatically adjust engaging tooth number according to extent of torsion as claimed claim 1, wherein the radius of said ratchet ring is 30 mm, and the radius of said concave arcuate surface is between 30.5 mm and 31 mm.

3. The ratchet wrench able to automatically adjust engaging tooth number according to extent of torsion as claimed claim 1, wherein said ratchet ring is formed with a plurality of driving teeth, and said driving teeth of said ratchet ring are acute angles.

4. The ratchet wrench able to automatically adjust engaging tooth number according to extent of torsion as claimed claim 3, wherein said ratchet ring is formed with at least 108 driving teeth.
